(19) United States
(12) Patent Application Publication
(10) Pub. No.: US 2004/0255945 A1
(43) Pub. Date: Dec. 23, 2004

(54) Security-equipped window of a hyperbaric chamber for objects to be passed through

(76) Inventor: Kuo-Chung Cheng, Ba-De City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/463,339

(22) Filed: Jun. 18, 2003

(51) Int. Cl. A61G 10/00

(52) U.S. Cl. 128/205.26

(57) ABSTRACT

A medical lock is provided to a hyperbaric chamber for objects to be passed through, which includes a tube secured to a shell of a hyperbaric chamber, an inner plate for sealing an inner end of the tube, a circular outer plate for sealing an outer end of the tube, and a security assembly, which has a locking rod movable in a direction parallel to an axis of the tube; the locking rod will fit into a cavity of the outer plate when the inner plate is opened, and will be forced to retreat from the cavity when the inner plate is moved to the closed position; therefore, the outer plate is prevented from turning to an unlocked position by means of the locking rod when the inner plate is in the opened position.

### BACKGROUND OF THE INVENTION

1. Field of the invention

The present invention relates to a window of a hyperbaric chamber for objects to be passed through, more particularly one, which is structured such that an outer window plate thereof is automatically locked when an inner window plate is in the opened position, preventing high pressure air in the chamber from making the outer window plate move outwards violently to hurt people when the inner window plate is in the opened position.

2. Brief Description of the Prior Art

Hyperbaric chambers are used for the treatment of people suffering from decompress sickness (DCS), in which high concentration of oxygen is supplied to people when the people are seated in the chamber, in which the chamber pressure is higher than the atmosphere. Because such hyperbaric treatment takes extended period of time, people receiving treatment in the chamber might need to have foods, drinks, and blanket passed to them by people outside the chamber during the treatment.

Referring to FIGS. 19, and 20, a hyperbaric chamber is provided with a window for objects to be passed through; the window includes a tube 61, an inner medical lock plate 62, an outer medical lock plate 63, a pressure gauge 64, and pressure-equivalent valves 65, 66. The tube 61 provides a passage for objects, and is secured to a shell 60 of the chamber with inner, and outer ends thereof being inside, and outside the chamber respectively. The inner widow plate 62 is used for openably sealing the inner end of the tube 61 while the outer widow plate 63 is used for openably sealing the outer end of the tube 61. The pressure-equivalent valves 65, 66 are respectively joined to outer, and inner end portions of the tube 61, and the pressure gauge 64 is arranged outside the chamber.

To pass objects to people inside the chamber via the medical lock, people outside the chamber control the valve 65 to make air pressure in the tube 61 become equal to that of the atmosphere, and then open the outer plate 63, and put the objects in the tube 61, and close the window plate 63 in sequence. Afterwards, people inside the chamber control the valves 66 to make air pressure in the tube 61 become equal to that in the chamber, and open the inner plate 62 to take the objects.

The medical lock provides a passage for objects to be given to people inside the chamber. However, high pressure air in the chamber will make the outer plate 63 move outwards fast if the outer plate 63 is unlocked when the inner window plate 62 is not closed and secured in position properly, prone to cause danger.

### SUMMARY OF THE INVETNION

It is a main object of the present invention to provide a hyperbaric chamber with a medical lock for objects to be passed through, of which an outer plate, provided for sealing outer end of a tube secured to the chamber, will be automatically locked when an inner plate, provided for sealing inner end of the tube, is in the opened position, so that the medical lock is safe to use.

It is another object of the present invention to make the medical lock more convenient to use; an air passage can be formed automatically on the inner plate to allow air pressure in the tube to become equal to that in the chamber on the course of the inner plate being unlocked; an air passage can be automatically formed on the outer plate to allow air pressure in the tube to become equal to that in the atmosphere at the early stage of the course of the outer plate being unlocked.

The medical lock has a security assembly, which is disposed in the tube, and which consists of a gear, and an actuating rod and a locking rod both movable in a direction substantially parallel to an axis of the tube, and both engaging the gear on opposing sides so that linear movement of one will be transmitted to other, and both will always move in opposite directions; the actuating rod is biased towards the inner plate with a first spring; the locking rod is biased towards the outer plate with a second spring so as to be capable of fitting into a cavity on an inner side of the outer plate when the outer plate is opened. Therefore, the outer plate is prevented from unlocking by means of the locking rod when the inner plate is in the closed position.

### BRIEF DESCRIPTION OF THE DRAWINGS

The present invention will be better understood by referring to the accompanying drawings, wherein:

FIG. 1 is a cross-sectional view of the medical lock according to the present invention,

FIG. 2 is a cross-sectional view of the inner plate of the medical lock of the invention, in the closed position,

FIG. 3 is a front view of the inner plate of the medical lock of the invention, in the closed position,

FIG. 4 is a partial cross-sectional view of the inner plate of the medical lock of the invention, in the closed position,

FIG. 5 is a cross-sectional view of the inner plate of the medical lock of the invention, in the unlocked position,

FIG. 6 is a partial cross-sectional view of the inner plate of the medical lock of the invention, in the unlocked position,

FIG. 7 is a front view of the inner plate of the medical lock of the invention, in the unlocked position,

FIG. 8 is a cross-sectional view of the inner plate of the medical lock of the invention, in the opened position,

FIG. 9 is a cross-sectional view of the outer plate of the medical lock of the invention, in the closed and locked position,

FIG. 10 is a front view of the outer plate of the medical lock of the invention, in the closed position,

FIG. 11 is a cross-sectional view of the outer plate of the medical lock of the invention, in an unsealing position,

FIG. 12 is a front view of the outer plate of the medical lock of the invention, in the unsealing position,

FIG. 13 is a front view of the outer plate of the medical lock of the invention, in the unlocked position,

FIG. 14 is a cross-sectional view of the outer plate of the medical lock of the invention, in the opened position,

FIG. 15 a top view of the security assembly according to the invention with the inner plate being in the closed position,

FIG. 16 is a side view of the security assembly according to the invention with the inner plate being in the closed position,

FIG. 17 is a top view of the security assembly, in the securing position preventing the outer plate from being unlocked,

FIG. 18 is a side view of the security assembly, in the securing position preventing the outer plate from being unlocked,

FIG. 19 is a perspective view of the conventional hyperbaric chamber as described in the Background, and

FIG. 20 is a cross-sectional view of the conventional medical lock of a hyperbaric chamber.

### DETAILED DESCRIPTION OF THE PREFERRED EMBODIMENTS

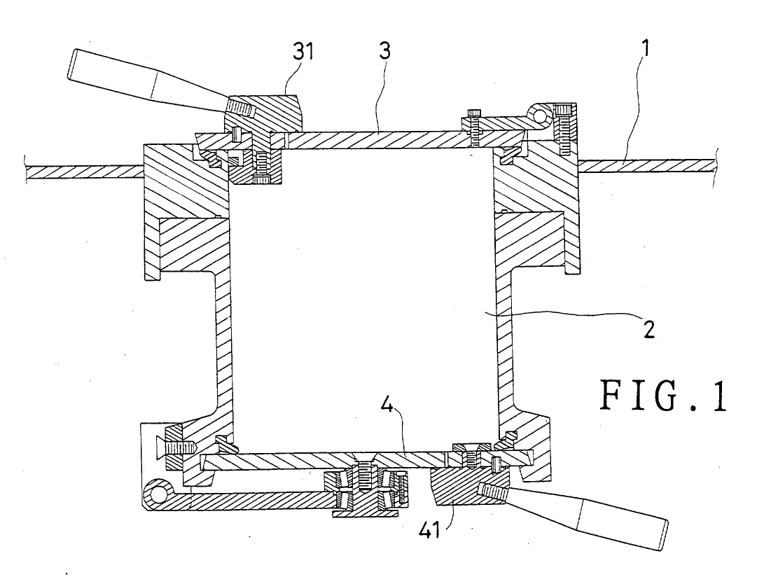

Referring to FIG. 1, a preferred embodiment of a medical lock of a hyperbaric chamber for objects to be passed through in the present invention includes a tube 2 providing a passage of objects to inside of the chamber, an inner plate 3 provided for openably sealing an inner end of the tube 2, an outer plate 4 provided for openably sealing an outer end of the tube 2, and a security assembly 5.

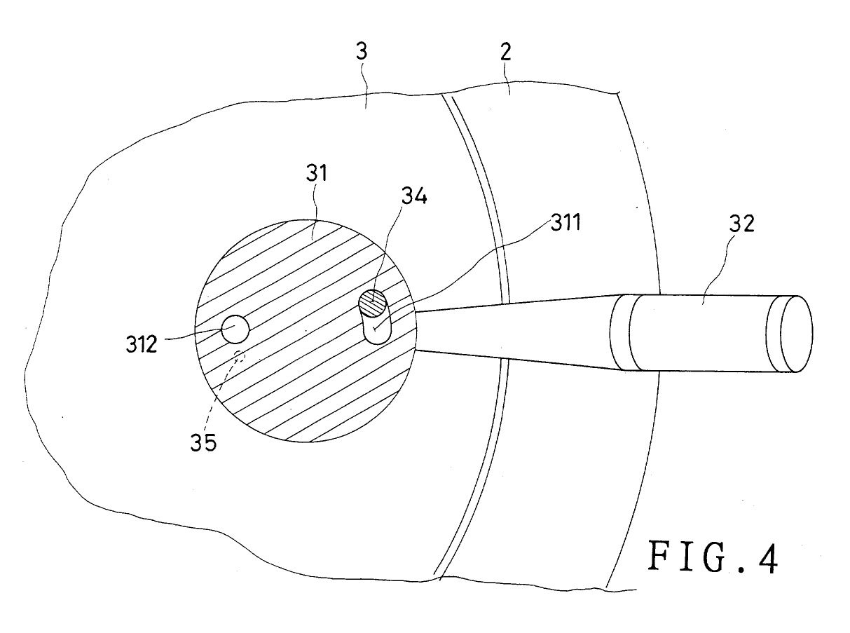

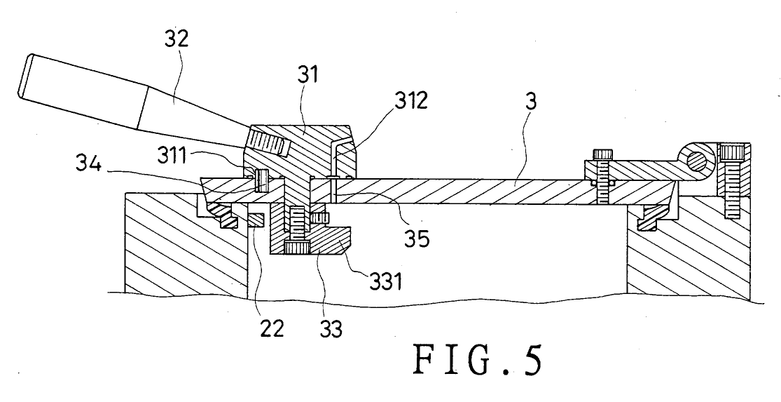

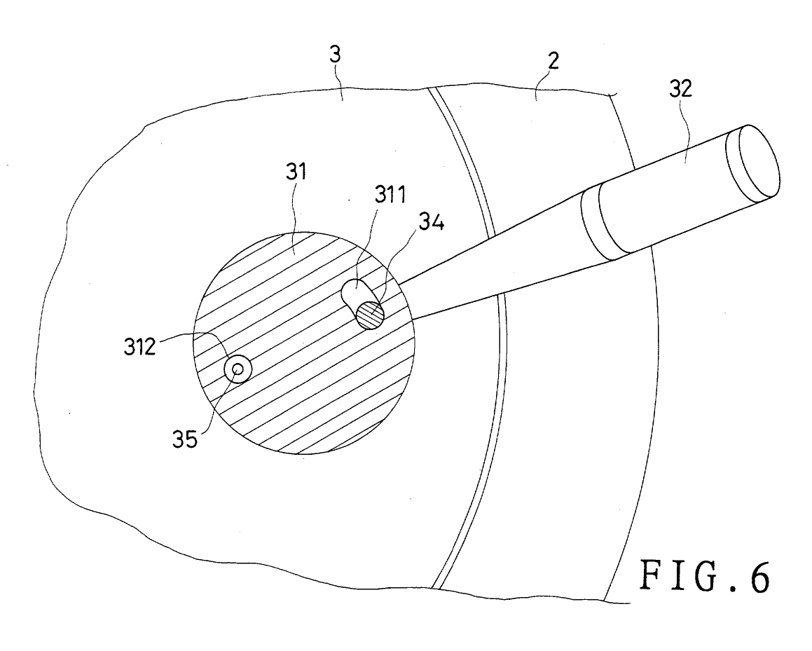

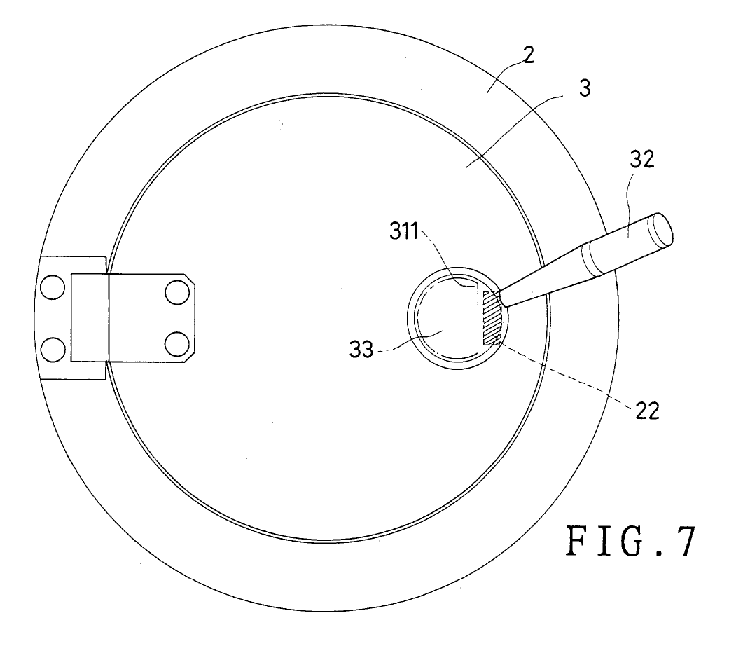

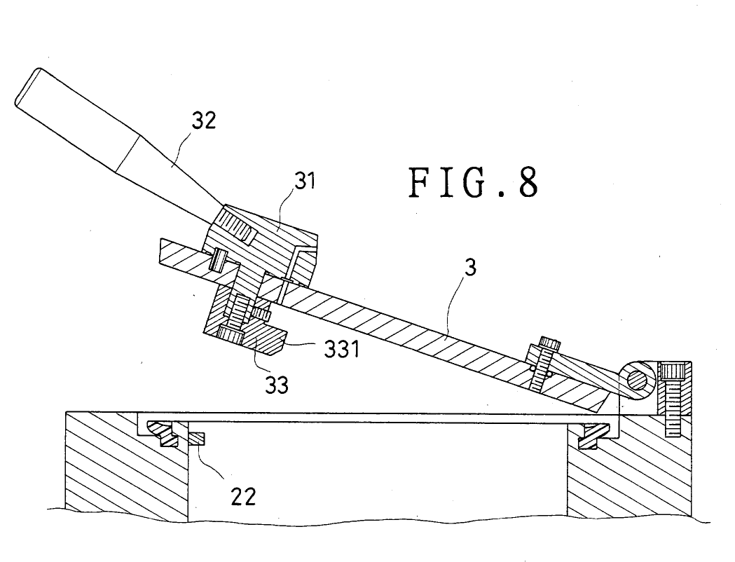

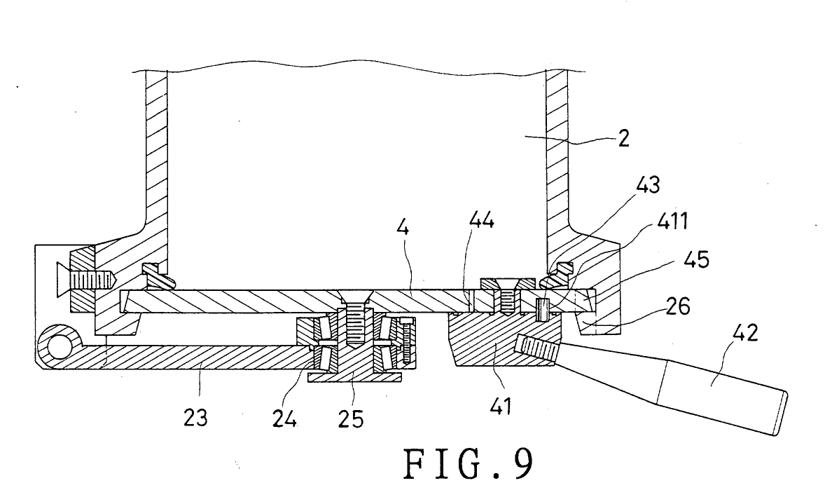

The tube 2 is securely joined to a shell 1 of the chamber with the inner, and the outer ends thereof being inside, and outside the hyperbaric chamber respectively. A pivotal bar 21 is pivoted to the inner end of the tube 2, and the inner plate 3 is joined to the pivotal bar 21 so as to be pivotal on the tube 2 between closed and opened positions. The tube 2 further has a locking protrusion 22 on an inner side of the inner end thereof. An elongated bar 23 is pivoted to the outer end of the tube 2, and a turning element 25 is fitted in a bearing 24 to be rotary, which bearing 24 is connected to an inner end of the bar 23. The outer plate 4 is circular, and joined to the turning element 25 at a middle thereof so as to be rotary about the middle thereof plus movable together with the elongated bar 23 between closed and opened positions, as shown in FIG. 4. The tube 2 further has several engaging blocks 26 spaced apart on an inner side of the outer end thereof.

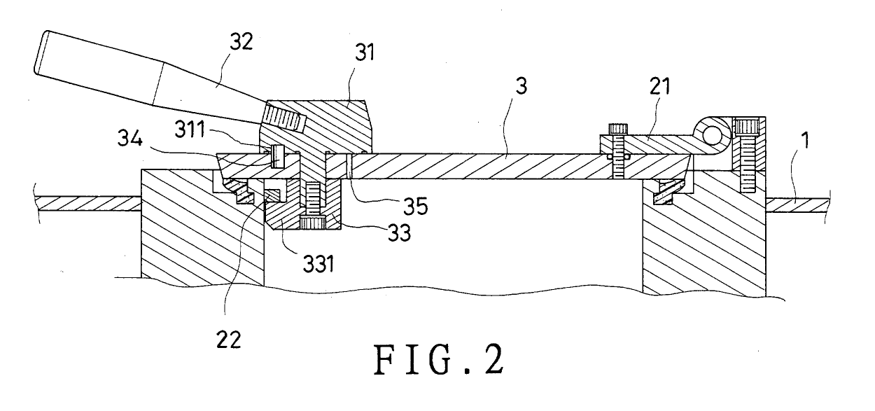

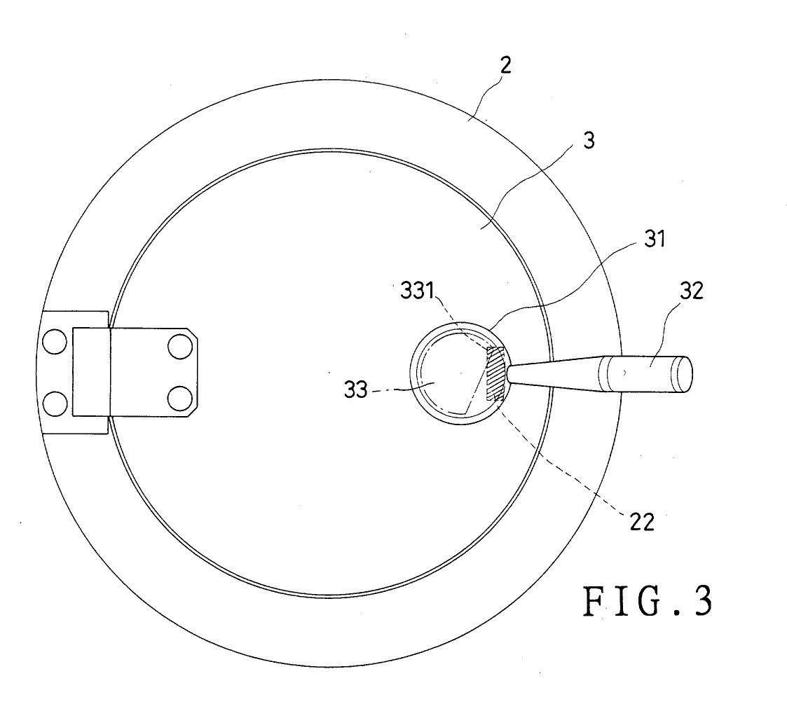

A turnable block 31 is fitted to an inward side of the inner plate 3 while a locking block 33 is disposed near to an outward side of the inner plate 3, and joined to the turnable block 31 so as to be rotary together with the turnable block 31, as shown in FIG. 3. Referring particularly to FIGS. 2, and 4, the turnable block 31 is formed with a curved slot 311, which is passed around a limiting post 34 of the inner plate 3; thus, rotation of the block 31 is limited to certain range. The locking block 33 has an engaging portion 331, which will engage the locking protrusion 22 of the tube 2 to lock the inner plate 3 in the closed position when the block 31 is turned to a first position where the upper end of the curved slot 311 abuts the limiting post 34. The turnable block 31 is formed with an air passage 312, which can become in communication with a through hole 35 of the inner plate 3 when the block 31 is turned to a second position where the lower end of the curved slot 311 abuts the limiting post 34, as shown in FIG. 3; when the block 31 is in the first position, the air passage 312 doesn't communicate with the through hole 35. A handle 32 is secured to the turnable block 31 for controlling the block 31 with. Therefore, when the block 31 is turned to the second position, air of higher pressure in the chamber will travel into the tube via the passage 312 and the through hole 35 until air pressure in the tube 2 becomes equal to that in the chamber, and the inner window plate 3 is unlocked, and can be opened.

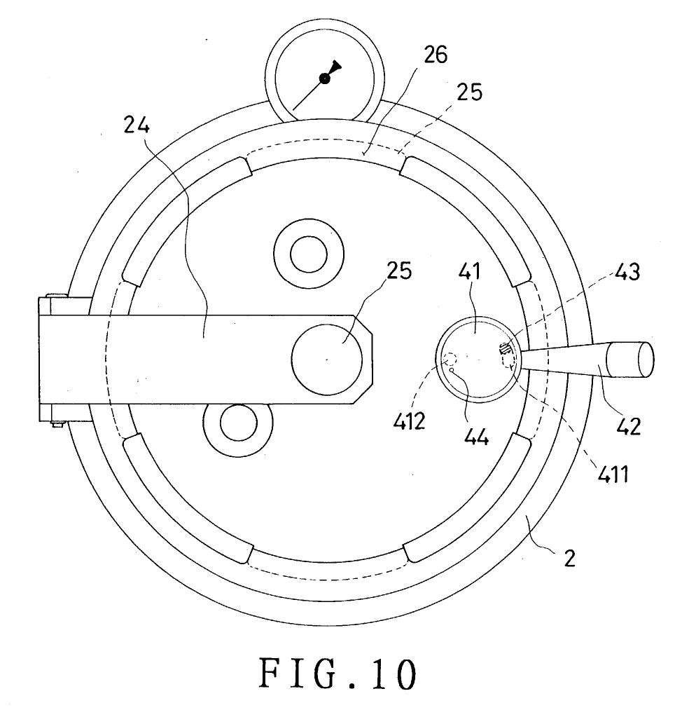

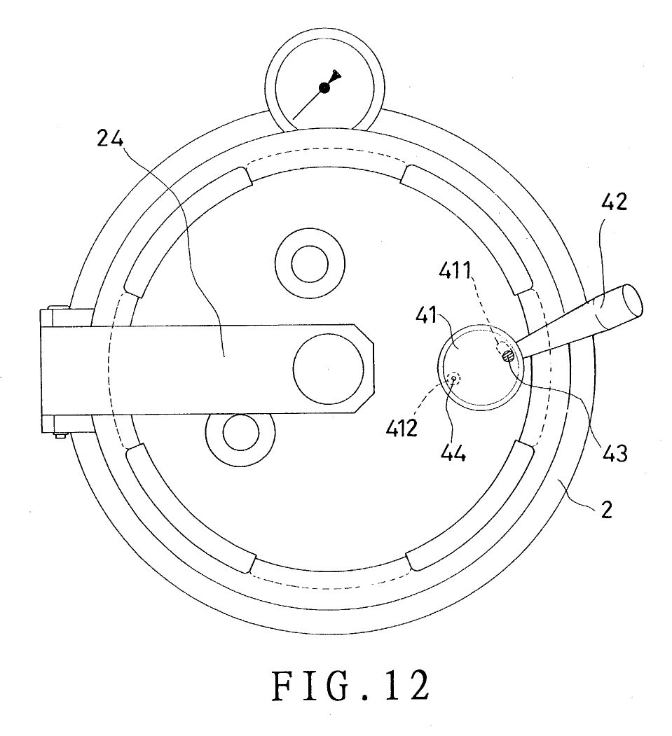

A turnable block 41 is turnably fitted to an outward side of the outer plate 4 while a handle 42 is joined to the block 41 for controlling the block 41 with. The block 41 is formed with a curved slot 411, which is positioned around a limiting post 43 of the outer plate 4; thus, rotation of the block 41 is limited to certain range. The outer plate 4 further has a through hole 44, and engaging protrusions 45 spaced apart on the edge. The block 41 has an air passage 412, which doesn't communicate with the through hole 44 when the block 41 is turned to a first position where the upper end of the curved slot 411 abuts the limiting post 43, as shown in FIG. 10; the passage 412 will communicate with the through hole 44 when the block 41 is turned to a second position where the lower end of the curved slot 411 abuts the limiting post 43, as shown in FIG. 12.

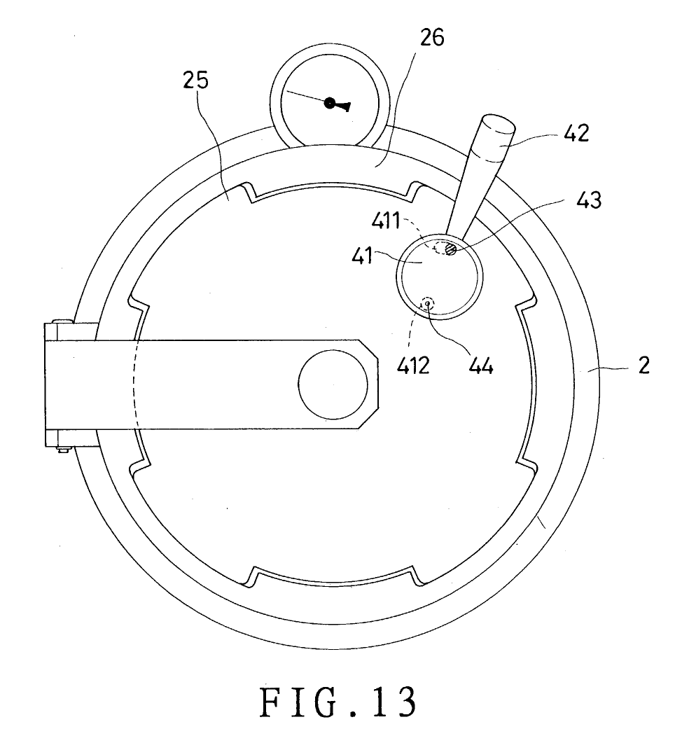

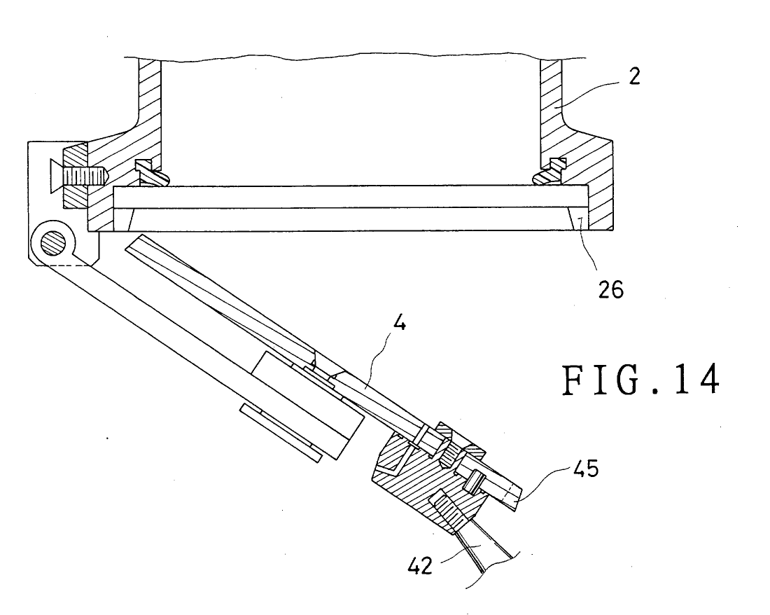

The engaging protrusions 45 normally engage respective ones of the engaging blocks 26 of the tube 2 so that the inner plate 4 is locked in position, and can't be opened. The outer plate 4 can be turned counterclockwise to an unlocked position with force being exerted on the handle 42, in which unlocked position the engaging protrusions 45 disengage the engaging blocks 26, as shown in FIG. 13; thus, the outer plate 4 can be opened, pivoted away from the tube 2 together with the elongated bar 23, as shown in FIG. 14.

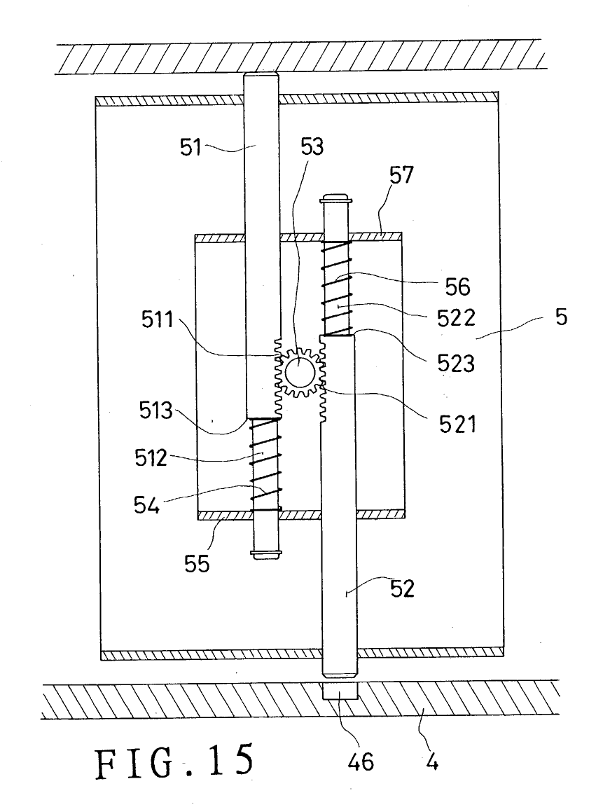

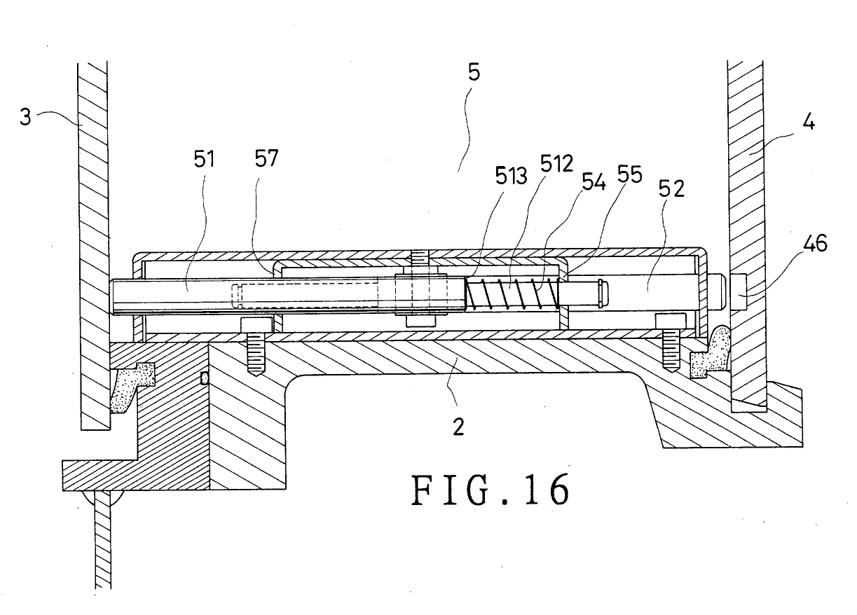

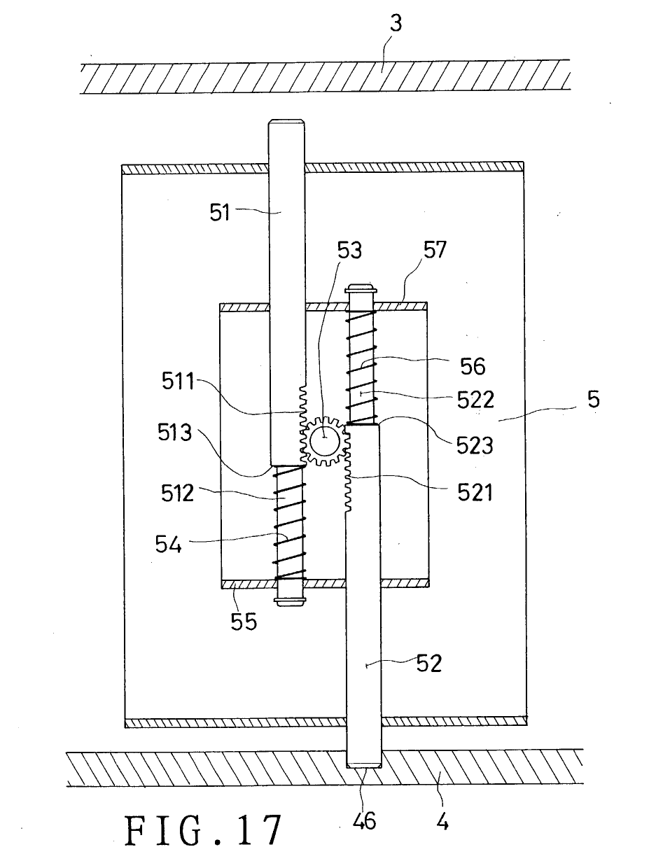

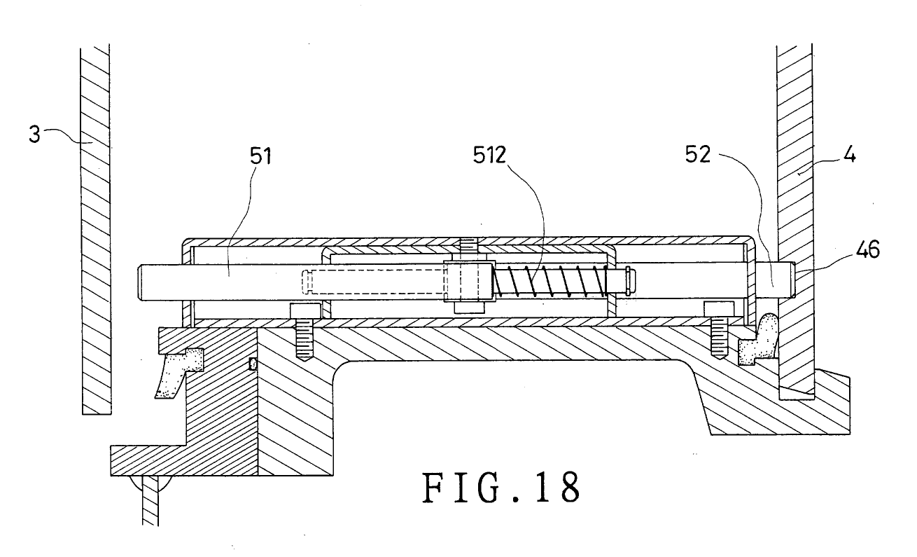

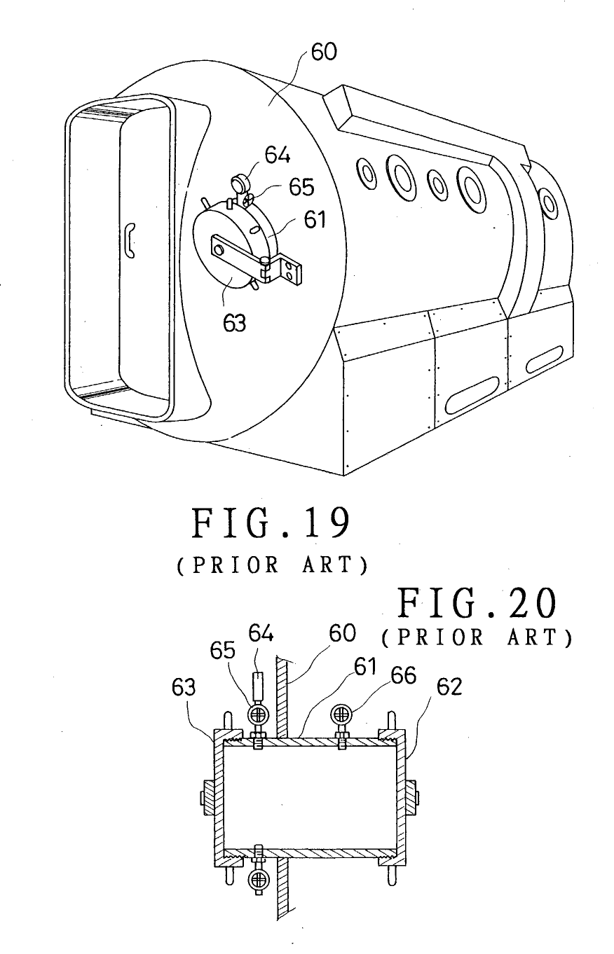

Referring to FIG. 15, the security assembly 5 is arranged in the tube 2, and consists of a pair of spaced apart parallel stationary plates 55, 57 securely joined to the tube 2, an actuating rod 51, a locking rod 52, and a gear 53. The actuating rod 51 has a first end portion passed through the stationary plate 57, and a thinner tail portion 512 passed through the stationary plate 55 so as to be movable in a direction substantially parallel to an axis of the tube 2; the actuating rod 51 further has a step-shaped portion 513 formed at the joint between the first end portion and the thinner tail portion 512, and a toothed portion 511 engaging the gear 53. The thinner tail portion 512 is passed through a spring 54, which is disposed between the step-shaped portion 513 and the plate 55, so that the spring 54 can bias the actuating rod 51 towards the inner plate 3. The locking rod 52 is disposed parallel to the actuating rod 51, and has a first end portion passed through the stationary plate 55, a thinner tail portion 522 passed through the stationary plate 57, a step-shaped portion 523 formed at the joint between the first end portion and the thinner tail portion 522, and a toothed portion 521 engaging the gear 53. The thinner tail portion 522 is passed through a spring 56, which is disposed between the step-shaped portion 523 and the plate 57, so that the spring 56 can bias the locking rod 52 towards the outer plate 4, and that the rods 51, and 52 will always move in opposite directions. In addition, the outer plate 4 has a locking cavity 46 on the inward side for engaging the locking rod 52 when the inner plate 3 is opened, as shown in FIGS. 17, and 18; when the inner plate 3 is in the opened position, and the outer plate 4 in the closed position, the spring 56 is free to bias the locking rod 52 closer to the outer plate 4, and in turns, the front end of the locking rod 52 will be forced to pass into the locking cavity 46 by the spring 56. Therefore, the outer plate 4 cannot be turned to the openable position when the inner plate 3 is in the opened position. On the other hand, referring to FIGS. 15, and 16, when the inner plate 3 is closed to seal the inner end of the tube 2, it will push the actuating rod 51 inwardly of the tube 2 against the spring 54; thus, the locking rod 52 is made to move inwardly of the tube 2 by means of the gear 53 transmitting linear movement of the actuating rod 51 to the locking rod 52, and in turns, the front end of the locking rod 52 is retreated from the locking cavity 46, allowing the outer window plate 4 to be turned to the unlocked position.

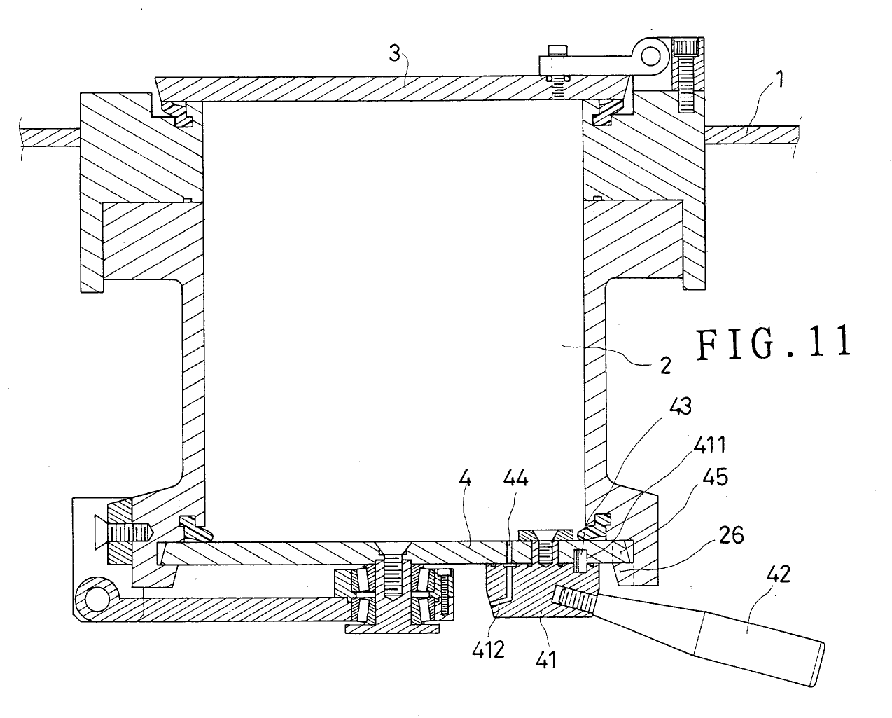

To pass objects to people inside the chamber, referring to FIGS. 11, and 12, firstly, the handle 42 is pushed to turn the turnable block 41 counterclockwise until the lower end of the curved slot 411 abuts the limiting post 43 plus the air passage 412 communicates with the through hole 44 so that air pressure in the tube 2 becomes equal to that of the atmosphere. Secondly, the handle 42 is pushed to make the outer plate 4 turn counterclockwise until the engaging protrusions 45 of the edge of the outer plate 4 is unlocked from the engaging blocks 26, as shown in FIG. 13; afterwards, the outer plate 4 is opened with the elongated bar 23 being pivoted away from the tube 2, and objects put in the tube 2. Thirdly, the handle 32 is pushed to turn the turnable block 31 counterclockwise until the lower end of the curved slot 311 abuts the limiting post 34 plus the air passage 312 communicates with the through hole 35 so that air pressure in the tube 2 becomes equal to that inside the hyperbaric chamber. Thus, the engaging portion 331 disengages the locking protrusion 22, and people in the chamber can open the inner plate 3 to take the objects passed to them.

From the above description, it can be easily understood that the medical lock of a hyperbaric chamber of the present invention has advantages as followings:

1. A passage will come into existence on the outer window plate 4 for air pressure in the tube to become equal to that of the atmosphere at the early stage of the course of the handle 42 being pushed to unlock the outer plate 4 therefore there is no possibility of a user forgetting to first making the air pressure in the tube become equal to that of the atmosphere before he opens the outer plate 4, and in turns, the outer window plate is safe to use.

2. Both the operation of making air pressure in the tube to become equal to that of the atmosphere and the operation of unlocking the outer plate can be completed with single handle, i.e. a user doesn't have to operate other pressure-equivalent valves or levers to make air pressure in the tube to become equal to that of the atmosphere before he unlocks the outer window plate, therefore the window is convenient to use.

3. Similar to what is mentioned above, an air passage will automatically come into existence on the inner plate 3 for air pressure in the tube to become equal to that inside the chamber when the handle 32 is being pushed to unlock the inner plate, and both the operation of making air pressure in the tube to become equal to that inside the chamber and the operation of unlocking the inner plate can be completed with single handle therefore the inner plate is convenient and safe to use.

4. The security assembly can lock the outer plate automatically when the inner plate is in the opened position, preventing high-pressure air in the chamber from making the outer window plate move violently to hurt people when the inner plate is in the opened position.

What is claimed is:

1. A medical lock of a hyperbaric chamber for objects to be passed through, comprising
a tube secured to a shell of a hyperbaric chamber;
an inner plate for sealing an inner end of the tube with; the inner plate being securely joined to a bar, which is pivoted to the tube, at an edge thereof; the inner plate having a first rotary block fitted thereon; a first handle being joined to the first rotary block for operation of same; a locking block being arranged in the tube and joined to the first rotary block; the locking block being capable of being turned together with the first rotary block between a locked position where it engages a locking protrusion on an inner side of the tube and an unlocked position where it is disengaged from the locking protrusion; the first rotary block having an air passage, which can become in communication with a through hole of the inner plate when the locking block is disengaged from the locking protrusion;
a circular outer plate for sealing an outer end of the tube with; the outer plate having a cavity on an inward side; the outer plate being joined to a first end of an elongated bar to be rotary about the first end of the elongated bar; the elongated bar being pivoted to the tube at a second end thereof; the outer plate having a second rotary block fitted thereon; the outer plate having a plurality of engaging protrusions spaced apart on an edge thereof; the second rotary block being formed with a curved slot, into which a limiting post projecting from the outer plate is passed; the outer plate being capable of being turned between a locked position where the engaging protrusions thereof engage respective ones of engaging blocks spaced apart on the outer end of the tube and an unlocked position where the engaging protrusions thereof disengage the engaging blocks; the second rotary block having an air passage, which can be made to communicate with a through hole of the outer plate during a course of the second rotary block being turned to the unlocked position; and
a security assembly consisting of a gear, and an actuating rod and a locking rod both movable in a direction substantially parallel to an axis of the tube, and both engaging the gear on opposing sides so that linear movement of one will be transmitted to other, and both will always move in opposite directions; the actuating rod being biased towards the inner plate with a first spring; the locking rod being biased towards the outer plate with a second spring so as to be capable of fitting into the cavity of the outer plate when the inner plate is opened; the locking rod being forced to retreat from the cavity of the outer plate by means of the inner plate when the inner plate is moved to a closed position forcing the actuating rod to move towards the outer plate against the first spring; whereby the outer plate is prevented from turning to the unlocked position by means of the locking rod when the inner plate is in the opened position.

2. The medical lock of a hyperbaric chamber for objects to be passed through as claimed in claim 1, wherein the first rotary block is formed with a curved slot while the inner plate has a limiting post projecting therefrom and passing into the curved slot of the first rotary block.

3. The medical lock of a hyperbaric chamber for objects to be passed through as claimed in claim 1, wherein a bearing is joined to the first end of the elongated bar while a turning element is fitted in the bearing, and securely joined to the middle of the circular outer plate.

4. A medical lock of a hyperbaric chamber for objects to be passed through, comprising a tube, an inner plate pivoted to an inner end of the tube, an outer plate pivoted to an outer end of the tube, and a security assembly;
the security assembly consisting of a gear, and an actuating rod and a locking rod both movable in a direction substantially parallel to an axis of the tube, and both engaging the gear on opposing sides so that linear movement of one will be transmitted to other, and both will always move in opposite directions; the actuating rod being biased towards the inner plate with a first spring; the locking rod being biased towards the outer plate with a second spring so as to be capable of fitting into a cavity formed on the outer plate when the inner plate is opened; the locking rod being forced to retreat from the cavity of the outer plate by means of the inner plate when the inner plate is moved to a closed position forcing the actuating rod to move towards the outer plate against the first spring; whereby the outer plate is prevented from turning to the unlocked position by means of the locking rod when the inner plate is in the opened position.

5. The medical lock of a hyperbaric chamber for objects to be passed through as claimed in claim 4, wherein the inner plate is securely joined to a bar, which is pivoted to the tube, at an edge thereof, and has a first rotary block fitted thereon; a first handle being joined to the first rotary block for operation of same; a locking block being arranged in the tube and joined to the first rotary block; the locking block being capable of being turned together with the first rotary block between a locked position where it engages a locking protrusion on an inner side of the tube and an unlocked position where it is disengaged from the locking protrusion; the first rotary block having an air passage, which can become in communication with a through hole of the inner plate when the first rotary block is turned for the locking block to be disengaged from the locking protrusion.

6. The medical lock of a hyperbaric chamber for objects to be passed through as claimed in claim 5, wherein the first rotary block is formed with a curved slot while the inner plate has a limiting post projecting therefrom and passing into the curved slot of the first rotary block.

7. The medical lock of a hyperbaric chamber for objects to be passed through as claimed in claim 4, wherein the outer plate is joined to a first end of an elongated bar so as to be rotary about the first end of the elongated bar while the elongated bar is pivoted to the tube at a second end thereof; the outer plate having a second rotary block fitted thereon; the outer plate having a plurality of engaging protrusions spaced apart on an edge thereof; the second rotary block being formed with a curved slot, into which a limiting post projecting from the outer plate is passed; the outer plate being capable of being turned between a locked position where the engaging protrusions thereof engage respective ones of engaging blocks spaced apart on the outer end of the tube and an unlocked position where the engaging protrusions thereof are disengaged from the engaging blocks; the second rotary block having an air passage, which can be made to communicate with a through hole of the outer plate during a course of the second rotary block being turned to the unlocked position.

8. The medical lock of a hyperbaric chamber for objects to be passed through as claimed in claim 7, wherein a bearing is joined to the first end of the elongated bar while a turning element is fitted in the bearing, and securely joined to the middle of the circular outer plate.
